(19) United States
(12) Patent Application Publication
(10) Pub. No.: US 2025/0079727 A1
(43) Pub. Date: Mar. 6, 2025

(54) CONTACT ASSEMBLY AND METHOD OF MANUFACTURING A CONTACT ASSEMBLY

(71) Applicant: TE Connectivity Solutions GmbH, Schaffhausen (CH)

(72) Inventor: Marjorie Kay Myers, Mount Wolf, PA (US)

(21) Appl. No.: 18/459,067

(22) Filed: Aug. 31, 2023

(51) Int. Cl. H01R 4/30; H01R 43/02; H01R 43/16

(52) U.S. Cl. CPC H01R 4/304; H01R 43/0228; H01R 43/16

(57) ABSTRACT

A contact assembly includes a contact having an upper surface and a lower surface. The contact has a drill hole therethrough. The contact has a flashing collar surrounding the drill hole. The contact assembly includes a mating interposer bonded to the flashing collar to mechanically and electrically connect the mating interposer to the contact. The mating interposer has a mating interface configured to be mated to a terminal to electrically connect the terminal to the contact.

### BACKGROUND OF THE INVENTION

The subject matter herein relates generally to contact assemblies.

Contact assemblies are used to electrically connect various components or devices. For example, the contact assemblies may include contacts or terminals that are electrically connected. Some known contact assemblies are connected by a permanent connection, such as a welded connection. Other known contact assemblies are connected at a separable interface, such as using a threaded fastener. For example, an opening may be formed in the contact by a thermal friction drilling process and the threaded fastener may pass through the opening. The thermal friction drilling process forms a collar around the drill hole. However, a poor electrical connection may be formed at the interface between the collar and the mating contact or terminal of the mating contact assembly. Some known separable connections are made using a nut and bolt. Other known separable connections eliminate the use of the nut by forming threads directly into the opening in the contact using a threading device during a threading process.

A need remains for a cost effective and reliable contact assembly having separable interface for mating with a mating contact assembly.

### BRIEF DESCRIPTION OF THE INVENTION

In one embodiment, a contact assembly is provided and includes a contact having an upper surface and a lower surface. The contact has a drill hole therethrough. The contact has a flashing collar surrounding the drill hole. The contact assembly includes a mating interposer bonded to the flashing collar to mechanically and electrically connect the mating interposer to the contact. The mating interposer has a mating interface configured to be mated to a terminal to electrically connect the terminal to the contact.

In another embodiment, a contact assembly is provided and includes a contact having an upper surface and a lower surface. The contact has a drill hole therethrough. The contact has a flashing collar surrounding the drill hole at the upper surface. The contact assembly includes a mating interposer having a mating surface and a connecting surface. The connecting surface is connected to the flashing collar by metallurgical bonding to mechanically and electrically connect the mating interposer to the contact. The mating interposer has an opening therethrough aligned with the drill hole. The mating interposer has a separable mating interface at the mating surface configured to be mated to a terminal to electrically connect the terminal to the contact.

In a further embodiment, a method of manufacturing a contact assembly is provided and includes providing a contact has an upper surface and a lower surface. The method includes thermal friction drilling a drill hole in the contact to form a flashing collar around the drill hole. The method bonds a mating interposer to the flashing collar to form a separable mating interface configured to be mated to a terminal to electrically connect the terminal to the contact.

### BRIEF DESCRIPTION OF THE DRAWINGS

FIG. 1 is a side view of a contact assembly in accordance with an exemplary embodiment coupled to a terminal.

FIG. 2 is a top view of the contact assembly in accordance with an exemplary embodiment coupled to the terminal.

FIG. 3 is a top view of the contact assembly in accordance with an exemplary embodiment without the terminal to illustrate the components of the contact assembly.

FIG. 4 illustrates a thermal friction drilling process for forming the drill hole in the contact in accordance with an exemplary embodiment.

FIG. 5 illustrates a thermal friction drilling process for forming the drill hole in the contact in accordance with an exemplary embodiment.

FIG. 6 illustrates a thermal friction drilling process for forming the drill hole in the contact in accordance with an exemplary embodiment.

FIG. 7 illustrates a thermal friction drilling process for forming the drill hole in the contact in accordance with an exemplary embodiment.

FIG. 8 illustrates a thermal friction drilling process for forming the drill hole in the contact in accordance with an exemplary embodiment.

FIG. 9 is a side view of the contact assembly in accordance with an exemplary embodiment showing the mating interposer joined to the flashing collar of the contact.

FIG. 10 is a side view of a thermal friction drilling process for forming the drill hole in the contact in accordance with an exemplary embodiment.

FIG. 11 is a side view of the contact assembly in accordance with an exemplary embodiment showing the mating interposer joined to the upper flashing collar and the second mating interposer joined to the lower flashing collar.

FIG. 12 is a side view of the contact assembly in accordance with an exemplary embodiment showing terminals coupled to the mating interposers.

### DETAILED DESCRIPTION OF THE INVENTION

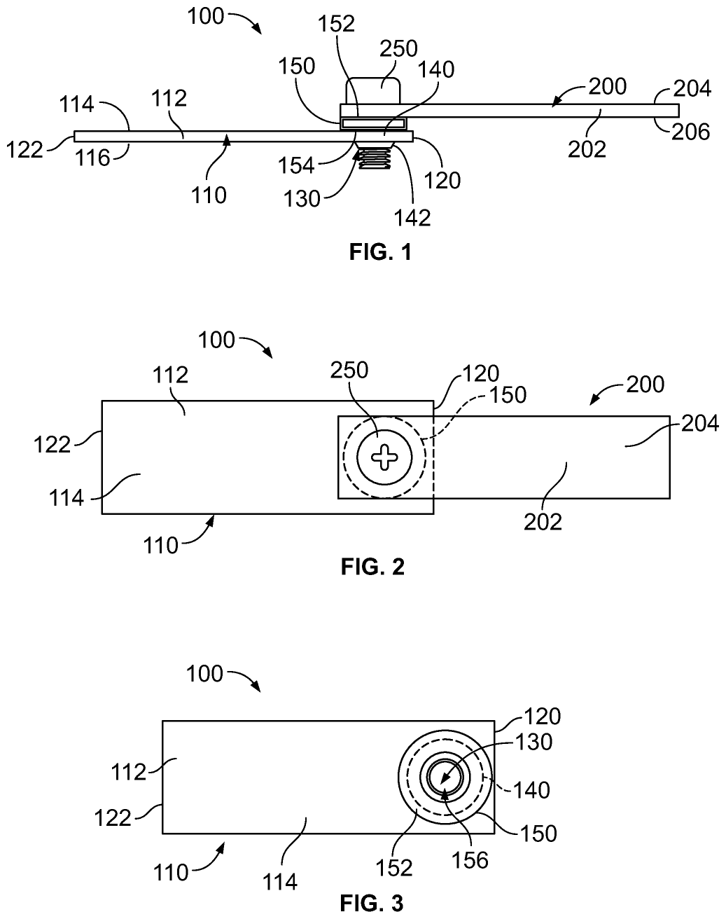

FIG. 1 is a side view of a contact assembly 100 in accordance with an exemplary embodiment coupled to a terminal 200. FIG. 2 is a top view of the contact assembly 100 in accordance with an exemplary embodiment coupled to the terminal 200. FIG. 3 is a top view of the contact assembly 100 in accordance with an exemplary embodiment without the terminal to illustrate the components of the contact assembly 100. The contact assembly 100 includes a contact 110 and a mating interposer 150 connected to the contact 110 to form a mating interface for mating with the terminal 200. The mating interposer 150 defines a mating interface between the contact 110 and the terminal 200. The mating interposer 150 has a mateable surface for mating to the terminal 200. The mating interposer 150 is connected to the contact 110 in a one step process. For example, the mating interposer 150 is connected electrically and mechanically as a hole in the contact 110 is formed during a hole forming process. In an exemplary embodiment, the mating interposer 150 is connected to the contact 110 without the need for a subsequent or separate welding or soldering process. The mating interposer 150 is connected to the contact 110 without the need for an interposer style part during assembly. The mating interposer 150 is connected to the contact 110 without the need for post-process plating. In an exemplary embodiment, the terminal 200 is connected to the contact assembly 100 using a fastener 250. The fastener 250 passes through the mating interposer 150 and may be threaded directly to the contact 110/mating interposer 150 or may be connected using a threaded nut (not shown) at the bottom of the assembly.

The contact 110 includes a body 112 having an upper surface 114 and a lower surface 116. The contact 110 may be a busbar in various embodiments. In various embodiments, the body 112 is planar. However, the body 112 may have other shapes in alternative embodiments, such as having one or more bends, such as being L-shaped. In other various embodiments, the body 112 may be hollow, such as having a cylindrical or rectangular in cross-section. The contact 110 is manufactured from a metallic material, such as aluminum, copper, steel, or an alloy thereof. The contact 110 may be coated or plated with one or more conductive layers. The contact 110 extends between a first end 120 and a second end 122. The mating interposer 150 in the terminal 200 are coupled to the contact 110 at the first end 120. The second end 122 may be connected to another component, such as a wire, a cable, a connector, a busbar, or an electrical device.

In an exemplary embodiment, the contact 110 includes an opening 130 at the first end 120 that receives the fastener 250. In an exemplary embodiment, the opening 130 is a drill hole formed by a thermal friction drilling process and may be referred to hereinafter as a drill hole 130. The thermal friction drilling process may be a flow drilling process in various embodiments. The drill hole 130 passes through the body 112 between the upper surface 114 and the lower surface 116. Optionally, the drill hole 130 may pass entirely through the body 112. Alternatively, the drill hole 130 may pass only partially through the body 112 (for example, open at the upper surface 114 and closed at the lower surface 116). In various embodiments, the drill hole 130 may be threaded by a threading device such that the fastener 250 may be threadably coupled to the contact 110 at the drill hole 130. In other various embodiments, the fastener 250 is connected to the contact 110/terminal 200 using a threaded nut (not shown) on the bottom side of the assembly. The threaded fastener 250 may extend partially or completely through the drill hole 130 and/or the nut (when used).

In an exemplary embodiment, during the forming of the drill hole 130, such as during the thermal friction drilling process, a flashing collar 140 is formed at the upper surface 114 and flashing collar 142 is formed at the lower surface 116. The flashing collar 140, 142 is a natural occurrence or byproduct of the thermal friction drilling process. In an exemplary embodiment, the mating interposer 150 is bonded to the flashing collar 140 to mechanically and electrically connect the mating interposer 150 to the flashing collar 140. Optionally, an additional mating interposer (not shown) may be bonded to the lower flashing collar 142 to provide an additional mating interposer on the bottom side of the contact assembly 100. In an exemplary embodiment, the mating interposer 150 is metallurgically bonded to the flashing collar 140 by connecting the mating interposer 150 to the flashing collar 140 when the flashing collar 140 is enabled state. For example, the mating interposer 150 is hot bonded to the flashing collar 140 prior to the flashing collar 140 returning to room temperature. When the flashing collar 140 is formed, the flashing collar 140 is flowable. In an exemplary embodiment, the mating interposer 150 is bonded to the flashing collar 140 when the flashing collar 140 is flowable. The metal material of the mating interposer 150 and the metal material of the flashing collar 140 may be intermixed by diffusion during the assembly process.

In an exemplary embodiment, the mating interposer 150 is a washer. The mating interposer 150 may be ring-shaped having a circular outer diameter. The mating interposer 150 may have other shapes in alternative embodiments. The mating interposer 150 may be flat or planar in various embodiments. In an exemplary embodiment, the mating interposer 150 has an opening therethrough. The opening may be enclosed (for example, at a center of the mating interposer 150) or may be opening or slot formed at a side of the mating interposer 150. The mating interposer 150 is manufactured from a metallic material, such as aluminum, copper, or an alloy thereof. In various embodiments, the mating interposer 150 is manufactured from a different material as the contact 110. For example, the contact 110 may be manufactured from an aluminum material in the mating interposer 150 may be manufactured from a copper material, or vice versa. However, in alternative embodiments, the mating interposer 150 and the contact 110 may be manufactured from the same material. The mating interposer 150 may be coated or plated with one or more conductive layers, such as silver or zinc.

The mating interposer 150 has a mating surface 152 at a top of the mating interposer 150 and a connecting surface 154 at a bottom of the mating interposer 150. The connecting surface 154 is configured to be connected to the flashing collar 140. For example, the connecting surface 154 may be pressed into the flashing collar 140 metallurgically bond the mating interposer 150 to the flashing collar 140 of the contact 110. In an exemplary embodiment, the mating surface 152 defines a separable mating interface for mating with the terminal 200. In various embodiments, the mating surface 152 may be flat or smooth and the terminal 200 is pressed into mating contact with the mating surface 152 by the fastener 250. In other various embodiments, the mating surface 152 may be non-planar, such as being a structured surface, a stepped surface, a curved surface, and the like. In alternative embodiments, the terminal 200 may be soldered or welded to the mating surface 152 of the mating interposer 150. For example, the mating surface 152 may define a weld pad for welding the terminal 200 to the mating surface 152. In an exemplary embodiment, the mating interposer 150 includes an opening 156 therethrough aligned with the drill hole 130 to receive the fastener 250.

The terminal 200 includes a body 202 having an upper surface 204 and a lower surface 206. In various embodiments, the body 202 is planar. However, the body 202 may have other shapes in alternative embodiments. The terminal 200 is manufactured from a metallic material, such as aluminum, copper, or an alloy thereof. The terminal 200 may be coated or plated with one or more conductive layers. The terminal 200 may be a busbar in various embodiments configured to be terminated to another component at the opposite end to transmit power between the component and the contact assembly 100. In other various embodiments, the terminal 200 may be a ring terminal for crimp barrel provided at the end of a wire or cable. In alternative embodiments, the terminal 200 may be a conductor of a wire or cable, which is terminated directly to the mating interposer 150, such as being welded or soldered to the mating interposer 150.

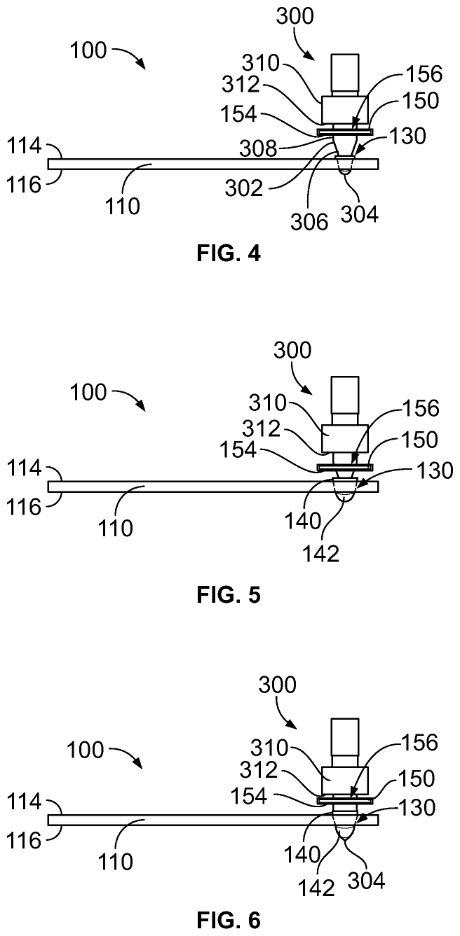

FIGS. 4 through 8 illustrate a thermal friction drilling process for forming the drill hole 130 in the contact 110. The thermal friction drilling process may be a flow drilling process in various embodiments. A thermal friction drilling device 300 is used to form the drill hole 130 in the contact 110 and the flashing collars 140, 142 at the upper and lower surfaces 114, 116 of the contact 110. The thermal friction drilling device 300 includes a drill bit 302 that is rotated at high speed to create friction with the contact 110 to increase the thermal temperature of the contact 110 in the area of the drill hole 130. With pressure, the drill bit 302 is able to drill through the contact 110 to form the drill hole 130. The flashing collars 140, 142 are formed at the upper and lower surfaces 114, 116 as the drill bit 302 passes into and through the contact 110. In an exemplary embodiment, the material of the contact 110 is heated to a flowable state, such as a state that allows plastic flow. The material of the contact 110 may be heated to a melting temperature causing molten material of the contact 110 to flow outward from the drill hole 130 to form the flashing collars 140, 142. However, the flashing material may be in a non-liquid state in other embodiments. In an exemplary embodiment, the mating interposer 150 is pressed onto the flashing collar 140 by the drill bit 302 to bond the mating interposer 150 to the flashing collar 140.

In an exemplary embodiment, the drill bit 302 includes a tip 304, a cone 306, a shaft 308, and a head 310. The shaft 308 is cylindrical. The head 310 is stepped radially outward relative to the shaft 308 to form a pressing surface 312 at the bottom of the head 310. The head 310 may also be cylindrical. In an exemplary embodiment, the mating interposer 150 is located on the end of the drill bit 302. For example, the shaft 308 passes through the opening 156 of the mating interposer 150. The mating interposer 150 may be located immediately below the head 310. During the thermal friction drilling process, the head 310 presses the mating interposer 150 into the flashing collar 140 to connect the mating interposer 150 to the flashing collar 140. In an exemplary embodiment, the mating interposer 150 forms the flashing collar 140. For example, the mating interposer 150 may compress or spread the flashing collar 140 outward along the upper surface 114 to flatten the flashing collar 140 and create a large connection area between the flashing collar 140 and the connecting surface 154 of the mating interposer 150.

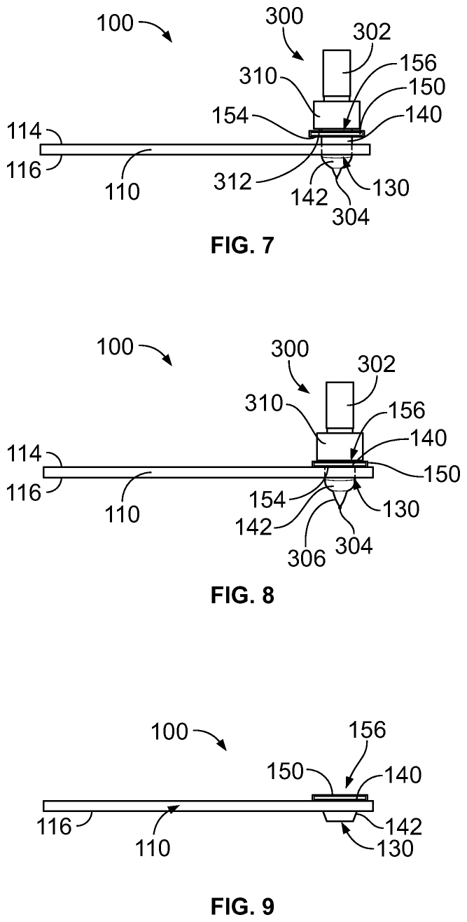

During the thermal friction drilling process, the drill bit 302 is operated to initially pierce (FIG. 4) the contact 110. The flowable material (for example, melted or molten material) of the contact 110 begins to flow out of the drill hole 130 (FIG. 5). For example, the flowable material of the contact 110 begins to flow upward along the cone 306 and downward along the tip 304. As the drill bit 302 continues to press through the contact 110 (FIG. 6), the drill hole 130 is widened and more flowable material of the contact 110 flows out of the drill hole 130. When the shaft 308 of the drill bit 302 is inserted into the drill hole 130 (FIG. 7), the diameter of the drill hole 130 is established and all of the flowable material is out of the drill hole 130 (for example, both above the upper surface 114 and below the lower surface 116).

As the drill bit 302 continues to press downward (FIG. 8), the pressing surface 312 of the head 310 presses the mating interposer 150 into the flowable material above the drill hole 130. The connecting surface 154 of the mating interposer 150 presses the flowable material outward to flatten the flowable material and form the flashing collar 140. The flowable material may experience plastic flow to form the flashing collar 140 in the space between the upper surface 114 of the contact 110 and the bottom surface of the mating interposer 150. Optionally, the flowable material may flow into the opening 156 of the mating interposer 150 and/or onto the top surface of the mating interposer 150 to increase surface area of the joint between the mating interposer 150 and the flashing collar 140. A hot bond is created between the mating interposer 150 and the flashing collar 140 to the elevated temperature of the flowable material as the mating interposer 150 is pressed into the flashing collar 140. Metallurgical bonding (for example chemical bonding) may occur between the mating interposer 150 and the flashing collar 140 to create a robust mechanical and electrical connection between the mating interposer 150 and the contact 110. The bonding between the mating interposer 150 and the flashing collar 140 may create intermetallic formations between the two components to enhance the connection between the mating interposer 150 and the flashing collar 140. The metallic elements of the mating interposer 150 and the flashing collar 140 may intermix, such as by diffusion between the metallic elements to create a reliable mechanical and electrical connection between the mating interposer 150 and the contact 110. As such, the thermal friction drilling process and the connection of the mating interposer 150 to the contact 110 occurs in a single process rather than requiring an assembly processes that occur at different assembly stations, which reduces the overall assembly time for the contact assembly 100. The connection of the mating interposer 150 to the contact 110 during the thermal friction drilling process eliminates or reduces post process step(s). For example, pre-plating of the contact 110 and the terminal 200 is not required. Post-process welding of a matable element is not required because the mating interposer 150 is connected to the contact 110 during the thermal friction drilling process. An interposer style interfacing component is not needed. Rather, the mating interposer 150 is mechanically and electrically connected to the contact 110 and defines a mateable surface for the terminal 200. In various embodiments, the drill hole does not need to be threaded during or after the drilling process.

With reference to FIGS. 4-8, a method of manufacturing a contact assembly includes providing a contact having an upper surface and a lower surface and thermal friction drilling a drill hole in the contact to form a flashing collar around the drill hole. Thermal friction drilling the drill hole includes heating the contact to an elevated temperature by friction during the thermal friction drilling process. The method includes bonding a mating interposer to the flashing collar to form a separable mating interface. The separable mating interface is configured to be mated to a terminal to electrically connect the terminal to the contact. Bonding the mating interposer may include metallurgically bonding the mating interposer to the flashing collar. Bonding the mating interposer may include hot bonding the mating interposer to the flashing collar prior to the flashing collar returning to room temperature. Bonding the mating interposer may include pressing the mating interposer into the flashing collar during thermal friction drilling of the drill hole. The method may include threading the drill hole and threadably coupling a fastener to the drill hole to secure the terminal to the contact.

FIG. 9 is a side view of the contact assembly 100 in accordance with an exemplary embodiment showing the mating interposer 150 joined to the flashing collar 140 of the contact 110. The lower flashing collar 142 extends below the lower surface 116 of the contact 110. Optionally, the drill hole 130 through the contact 110 and the flashing collars 140, 142 may be threaded, such as using a threading drill bit. Optionally, the opening 156 in the mating interposer 150 may additionally be threaded by the threading drill bit. However, the drill hole 130 and/or the mating interposer 150 do not need to be threaded. Rather a separate nut may be used.

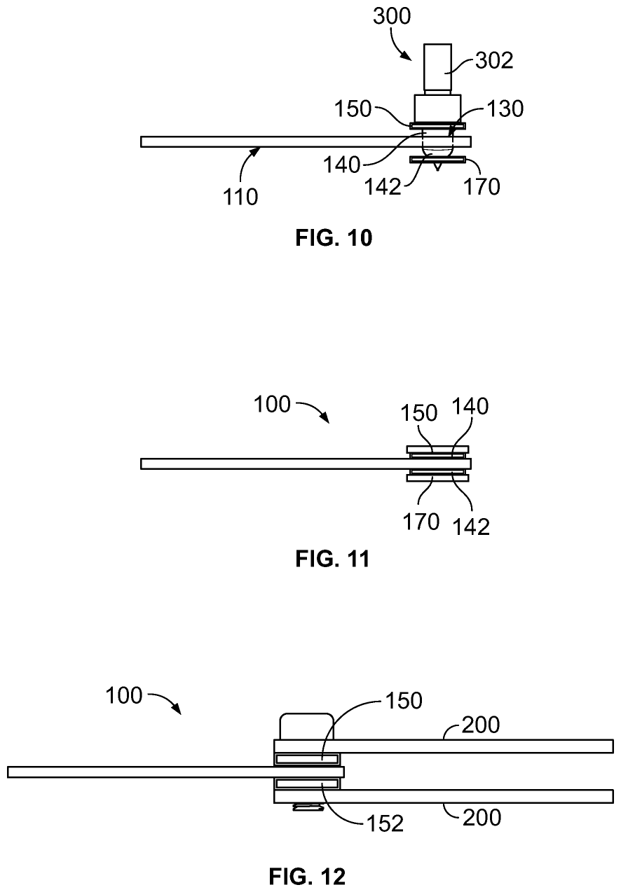

FIG. 10 is a side view of a thermal friction drilling process for forming the drill hole 130 in the contact 110 in accordance with an exemplary embodiment. In the illustrated embodiment, the mating interposer 150 is joined to the upper flashing collar 140 using the drill bit 302 of the thermal friction drilling device 300. A second mating interposer 170 is joined to the lower flashing collar 142 during the thermal friction drilling process. For example, the second mating interposer 170 be pressed into the flowable material formed during the thermal friction drilling process.

FIG. 11 is a side view of the contact assembly 100 in accordance with an exemplary embodiment showing the mating interposer 150 joined to the upper flashing collar 140 and the second mating interposer 170 joined to the lower flashing collar 142.

FIG. 12 is a side view of the contact assembly 100 in accordance with an exemplary embodiment showing terminals 200 coupled to the mating interposers 150, 170.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

What is claimed is:

1. A contact assembly comprising:
a contact having an upper surface and a lower surface, the contact having a drill hole therethrough, the contact having a flashing collar surrounding the drill hole; and
a mating interposer bonded to the flashing collar to mechanically and electrically connect the mating interposer to the contact, the mating interposer having a mating interface configured to be mated to a terminal to electrically connect the terminal to the contact.

2. The contact assembly of claim 1, wherein the mating interposer is metallurgically bonded to the flashing collar in a flowable state.

3. The contact assembly of claim 1, wherein the mating interposer is bonded to the flashing collar when the flashing collar is flowable.

4. The contact assembly of claim 1, wherein a temperature of the flashing collar is elevated during a thermal friction drilling process, the mating interposer being hot bonded to the flashing collar prior to the flashing collar returning to room temperature.

5. The contact assembly of claim 1, wherein the mating interposer is mechanically coupled to the flashing collar of the contact by inter-metallic formations between the mating interposer in the flashing collar.

6. The contact assembly of claim 1, wherein the mating interposer is bonded to the flashing collar during thermal friction drilling of the drill hole.

7. The contact assembly of claim 1, wherein the mating interposer is manufactured from a first metallic material, the contact being manufactured from a second metallic material different from the first metallic material.

8. The contact assembly of claim 1, wherein the mating interposer is manufactured from a first metallic material, the contact being manufactured from a second metallic material the same as the first metallic material.

9. The contact assembly of claim 1, wherein the mating interposer includes an opening aligned with the drill hole, the opening and the drill hole configured to receive a fastener used to secure the terminal to the mating interposer and the contact.

10. The contact assembly of claim 1, wherein the drill hole is threaded to receive a threaded fastener used to couple the terminal to the mating interposer in the contact.

11. The contact assembly of claim 1, wherein the flashing collar is an upper flashing collar at the upper surface, the contact having a lower flashing collar surrounding the drill hole at the lower surface, the contact assembly further comprising a second mating interposer bonded to the lower flashing collar to mechanically and electrically connect the second mating interposer to the contact.

12. A contact assembly comprising:
a contact having an upper surface and a lower surface, the contact having a drill hole therethrough, the contact having a flashing collar surrounding the drill hole at the upper surface; and
a mating interposer having a mating surface and a connecting surface, the connecting surface being connected to the flashing collar by metallurgical bonding to mechanically and electrically connect the mating interposer to the contact, the mating interposer having an opening therethrough aligned with the drill hole, the mating interposer having a separable mating interface at the mating surface configured to be mated to a terminal to electrically connect the terminal to the contact.

13. The contact assembly of claim 12, wherein a temperature of the flashing collar is elevated during a thermal friction drilling process, the mating interposer being hot bonded to the flashing collar prior to the flashing collar returning to room temperature.

14. The contact assembly of claim 12, wherein the flashing collar is an upper flashing collar at the upper surface, the contact having a lower flashing collar surrounding the drill hole at the lower surface, the contact assembly further comprising a second mating interposer bonded to the lower flashing collar to mechanically and electrically connect the second mating interposer to the contact.

15. A method of manufacturing a contact assembly comprising:
providing a contact having an upper surface and a lower surface;
thermal friction drilling a drill hole in the contact to form a flashing collar around the drill hole; and
bonding a mating interposer to the flashing collar to form a separable mating interface configured to be mated to a terminal to electrically connect the terminal to the contact.

16. The method of claim 15, wherein said bonding the mating interposer comprises metallurgically bonding the mating interposer to the flashing collar.

17. The method of claim 15, wherein said thermal friction drilling comprises heating the contact to an elevated temperature by friction during the thermal friction drilling process, said bonding the mating interposer comprises hot bonding the mating interposer to the flashing collar prior to the flashing collar returning to room temperature.

18. The method of claim 15, wherein said bonding the mating interposer comprises pressing the mating interposer into the flashing collar during thermal friction drilling of the drill hole.

19. The method of claim 15, further comprising threading the drill hole and threadably coupling a fastener to the drill hole to secure the terminal to the contact.

20. The method of claim 15, further comprising bonding a second mating interposer to the lower surface of the contact at the flashing collar extending from the lower surface.
